(19) United States
(12) Patent Application Publication
(10) Pub. No.: US 2018/0342361 A1
(43) Pub. Date: Nov. 29, 2018

(54) LUMINOUS KEYBOARD

(71) Applicant: Primax Electronics Ltd., Taipei (TW)

(72) Inventors: TSU-YI CHEN, Taipei (TW); TIEN-YU YEH, Taipei (TW); SHENG-FAN CHANG, Taipei (TW)

(21) Appl. No.: 15/814,846

(22) Filed: Nov. 16, 2017

(30) Foreign Application Priority Data
May 26, 2017 (TW) 106117647

(51) Int. Cl. H01H 13/83; F21V 8/00

(52) U.S. Cl. CPC H01H 13/83; H01H 3/125; G02B 6/0075

(57) ABSTRACT

A luminous keyboard includes an illumination module, a keycap and plural light-guiding structures. The illumination module generates a light beam. The keycap includes a character/symbol region. The plural light-guiding structures are disposed on a bottom surface of the specified keycap and aligned with the character/symbol region. The light beam to be projected to the specified keycap is guided to the character/symbol region by the light-guiding structures. The light-guiding structures of the luminous keyboard are arranged according to the layout of the character/symbol regions in different countries. It is not necessary to change the light-guiding structures of the light guide plate according to the layout of the character/symbol regions of different countries.

### FIELD OF THE INVENTION

The present invention relates to a keyboard, and more particularly to a luminous keyboard with an illuminating function.

### BACKGROUND OF THE INVENTION

Generally, the widely-used peripheral input device of a computer system includes for example a mouse device, a keyboard, a trackball device, or the like. Via the keyboard, characters and symbols can be inputted into the computer system directly. As a consequence, most users and most manufacturers of input devices pay much attention to the development of keyboards. The subject of the present invention is related to a keyboard device.

FIG. 1 is a schematic top view illustrating the outer appearance of a conventional keyboard. As shown in FIG. 1, there are plural keys 10 on a surface of the conventional keyboard 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1˜F12) can be programmed to provide various functions. For example, the conventional keyboard 1 is a keyboard for a notebook computer.

With the maturity of the computing technologies, the keyboard manufacturers make efforts in designing novel keyboards with special functions in order to meet diversified requirements of different users. For this reason, luminous keyboards are favored by users. Hereinafter, the inner structure of the luminous keyboard will be illustrated in more details. FIG. 2 is a schematic cross-sectional view illustrating a conventional luminous keyboard. As shown in FIG. 2, the conventional luminous keyboard 2 comprises plural keys 20, a membrane switch circuit member 21, a light guide plate 22, a light-emitting element 23, a base plate 24 and an illumination circuit board 25. For succinctness, only one key 20 is shown in the drawing. Each key 20 comprises a keycap 201, a scissors-type connecting element 202 and an elastic element 203. From top to bottom, the keycap 201, the scissors-type connecting element 202, the elastic element 203, the membrane switch circuit member 21 and the base plate 24 of the conventional luminous keyboard 2 are sequentially shown. The light-emitting element 23 and the illumination circuit board 25 are located beside the membrane switch circuit member 21. For example, the conventional luminous keyboard 2 is a keyboard for a notebook computer (not shown).

In the key 20, the keycap 201 is exposed outside the conventional luminous keyboard 2. Consequently, the keycap 201 can be depressed by the user. The keycap 201 and the base plate 24 are connected with each other through the scissors-type connecting element 202. The elastic element 203 is penetrated through the scissors-type connecting element 202. In addition, both ends of the elastic element 203 are contacted with the keycap 201 and the membrane switch circuit member 21, respectively. When the membrane switch circuit member 21 is pushed by the elastic element 203, a key signal is generated. The illumination circuit board 25 is located beside the membrane switch circuit member 21. The light-emitting element 23 is installed on the illumination circuit board 25. The light-emitting element 23 emits a light beam B to the light guide plate 22. The light guide plate 22 is used for guiding the light beam B to the keycap 201. For example, the light-emitting element 23 is a side-view light emitting diode.

As shown in FIG. 2, the keycap 201 has a character/symbol region 2011. The character/symbol region 2011 is exposed to the top surface of the keycap 201. That is, the character or symbol of the keycap 201 is shown on the character/symbol region 2011. Moreover, the light guide plate 22 comprises light-guiding dots 221. The light-guiding dots 221 are aligned with the character/symbol region 2011 and located under the character/symbol region 2011. After the light beam B from the light-emitting element 23 is introduced into the light guide plate 22, the light beam B is subjected to total internal reflection within the light guide plate 22. When the light beam B is projected on the light-guiding dots 221, the total internal reflection of the light beam B is destroyed by the light-guiding dots 221, and the light beam B is guided to the character/symbol region 2011 of the keycap 201 by the light-guiding dots 221. Consequently, the character/symbol region 2011 is illuminated.

However, since the languages used in different countries are usually different, some drawbacks occur. For example, the layout of the character/symbol region 2011 of the keycap 201 is designed according to the language of the corresponding country. That is, the layout of the character/symbol region 2011 for different countries is different. Take the keyboard used in Taiwan for example. The R key contains not only the character/symbol region “R” but also the character/symbol region “ [symbol] ”. As mentioned above, the light-guiding dots 221 of the light guide plate 22 of the conventional luminous keyboard 2 are aligned with the character/symbol region 2011. Generally, the light-guiding dots 221 are aligned with the character/symbol region “R” of the R key, but the light-guiding dots 221 are not aligned with the character/symbol region “ [symbol] ” of the R key. After the light beam B is projected on the light-guiding dots 221, a greater portion of the light beam B is guided to the character/symbol region “R” of the R key and a smaller portion of the light beam B is guided to the character/symbol region “ [symbol] ” of the R key. Since the light-guiding dots 221 of the conventional luminous keyboard 2 cannot match the layout of the character/symbol region 2011 of each country, the luminous efficacy of the conventional luminous keyboard 2 is not satisfied. For solving the above drawbacks, the light guide plate is equipped with light-guiding dots according to the layout of the character/symbol region of each country. As known, this approach is troublesome and not cost-effective.

Therefore, there is a need of providing a luminous keyboard for enhancing the luminous efficacy of the character/symbol region.

### SUMMARY OF THE INVENTION

An object of the present invention provides a luminous keyboard for enhancing the luminous efficacy of the character/symbol region.

In accordance with an aspect of the present invention, there is provided a luminous keyboard. The luminous keyboard includes an illumination module, plural keycaps and plural light-guiding structures. The illumination module generates a light beam. The plural keycaps are located over or above the illumination module. At least one specified keycap of the plural keycaps includes a character/symbol region. The character/symbol region is exposed to a top surface of the specified keycap. The light beam is projected to the keycap. The plural light-guiding structures are disposed on a bottom surface of the specified keycap and aligned with the character/symbol region. The light beam to be projected to the specified keycap is guided to the character/symbol region by the light-guiding structures, so that the character/symbol region is illuminated.

In an embodiment, the plural light-guiding structures are located under the character/symbol region.

In an embodiment, the plural light-guiding structures are arranged around an underlying position of the character/symbol region.

From the above descriptions, the present invention provides the luminous keyboard. The light-guiding structures are disposed on the bottom surface of the keycap. Consequently, the light-guiding structures are located under the corresponding character/symbol region or located near the corresponding character/symbol region. The light-guiding structures of the luminous keyboard are arranged according to the layout of the character/symbol regions in different countries. It is not necessary to change the light-guiding structures of the light guide plate according to the layout of the character/symbol regions of different countries. Consequently, the luminous keyboard of the present invention can overcome the drawbacks of the conventional technologies.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard;

FIG. 2 is a schematic cross-sectional view illustrating a conventional luminous keyboard;

FIG. 3 is a schematic cross-sectional view illustrating a luminous keyboard according to a first embodiment of the present invention;

FIG. 4 is a schematic top view illustrating a keycap of the luminous keyboard according to the first embodiment of the present invention;

FIG. 5 is a schematic cross-sectional view illustrating a luminous keyboard according to a second embodiment of the present invention; and

FIG. 6 is a schematic top view illustrating a keycap of the luminous keyboard according to the second embodiment of the present invention.

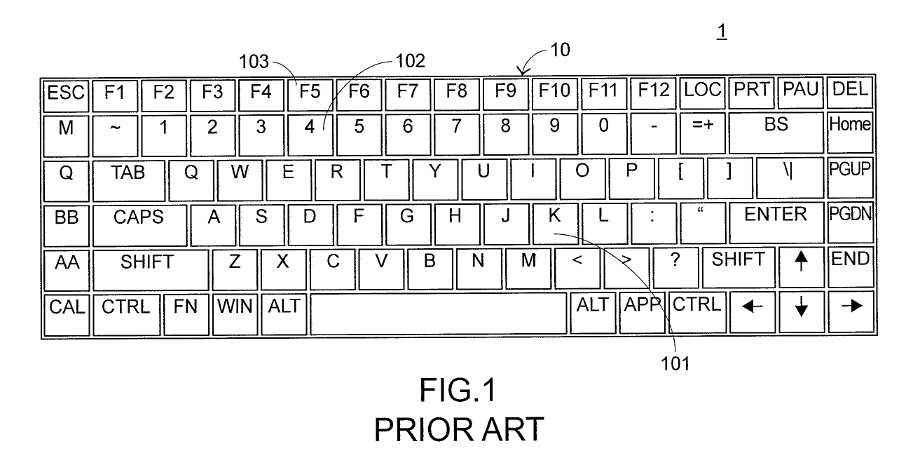

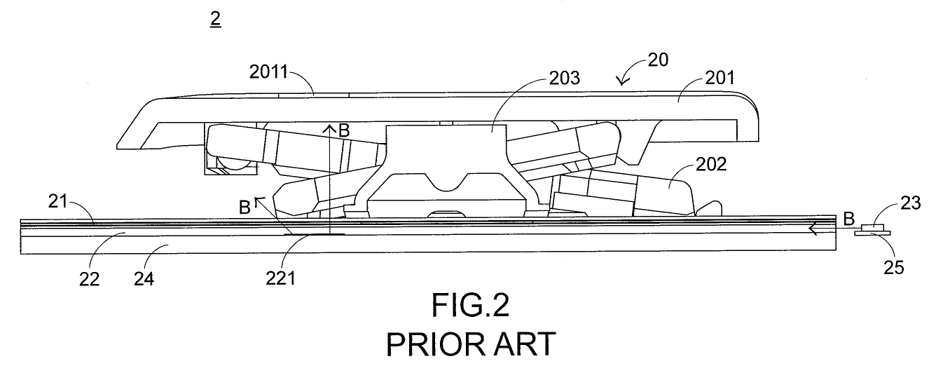

### DETAILED DESCRIPTION OF THE PREFERRED EMBODIMENT

For overcoming the drawbacks of the conventional technology, the present invention provides a luminous keyboard.

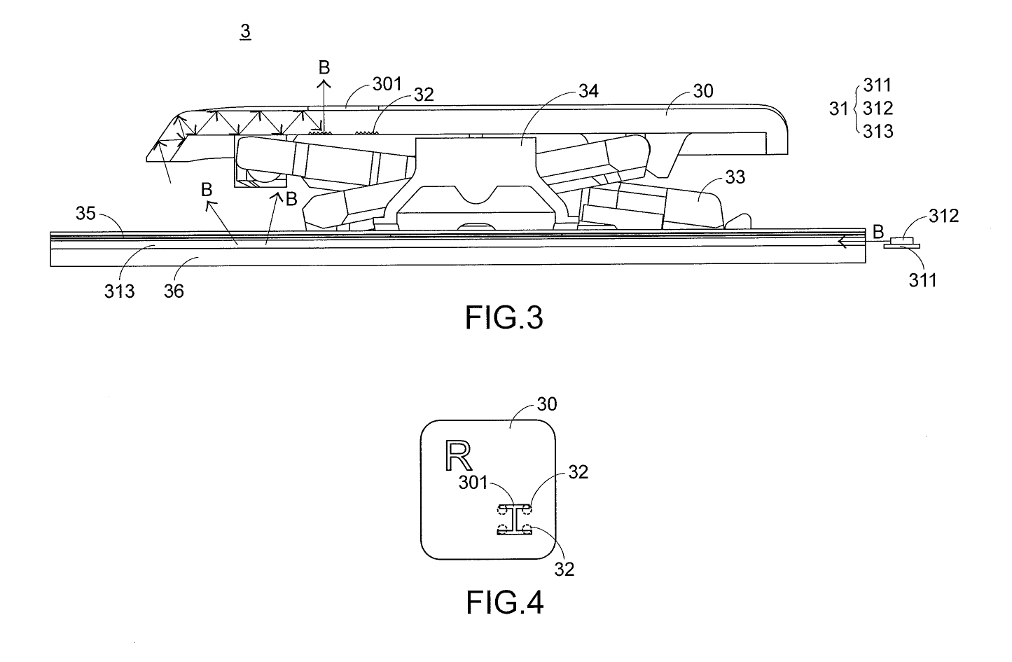

Please refer to FIGS. 3 and 4. FIG. 3 is a schematic cross-sectional view illustrating a luminous keyboard according to a first embodiment of the present invention. FIG. 4 is a schematic top view illustrating a keycap of the luminous keyboard according to the first embodiment of the present invention. Generally, the luminous keyboard 3 is installed on an installation base (not shown) of a portable electronic device (not shown). In this embodiment, the luminous keyboard 3 comprises plural keycaps 30, an illumination module 31, plural light-guiding structures 32, plural connecting elements 33, plural elastic elements 34, a switching circuit board 35 and a base plate 36. For succinctness, only one keycap 30, one connecting element 33 and one elastic element 34 are shown in the drawings. The plural keycaps 30 are exposed outside the installation base. Consequently, the keycaps 30 can be depressed by the user. When one of the keycaps 30 is depressed, a corresponding key signal is generated. After the key signal is transmitted to the portable electronic device (e.g., a notebook computer), a function corresponding to the depressed keycap 30 is executed by the portable electronic device. Each keycap 30 comprises plural character/symbol regions 301. The plural character/symbol regions 301 are exposed to a top surface of the keycap 30. For example, as shown in FIG. 4, the plural character/symbol regions 301 contain a character/symbol region “R” and a character/symbol region “ [symbol] ”. In an embodiment, the plural character/symbol regions 301 are formed on the top surface of the keycap 30 by a laser-engraving process. Consequently, the light beam can be transmitted through the character/symbol regions 301 to illuminate the character/symbol regions 301.

As shown in FIG. 3, the illumination module 31 comprises an illumination circuit board 311, a side-view light emitting element 312 and a light guide plate 313. The side-view light emitting element 312 is located below the keycap 30 and installed on the illumination circuit board 311. By acquiring electric power from the illumination circuit board 311, the side-view light emitting element 312 is driven to emit a light beam B. The light guide plate 313 is located under the keycap 30 and located beside the side-view light emitting element 312. The light guide plate 313 is used for guiding the light beam B to the keycap 30. The light guide plate 313 also comprises light-guiding dots, light-guiding microstructures or any other appropriate light-guiding structures. The function and structure of the light guide plate 313 are similar to those of the conventional light guide plate, and are not redundantly described herein. The connecting elements 33 are connected with the corresponding keycaps 30. Consequently, the keycaps 30 are moved upwardly or downwardly relative to the base plate 36. The elastic element 34 is located under the corresponding keycap 30. As the keycap 30 is moved to push the elastic element 34, the elastic element 34 is subjected to deformation. The switching circuit board 35 is located under the elastic element 34. When the switching circuit board 35 is triggered by the elastic element 34, a corresponding key signal is generated. The base plate 36 is located under the switching circuit board 35 and connected with the connecting elements 33. In this embodiment, the connecting elements 33 are scissors-type connecting elements, and the elastic elements 34 are rubbery elastomers.

As shown in FIGS. 3 and 4, the plural light-guiding structures 32 are disposed on a bottom surface of the keycap 30. Each character/symbol region 301 is aligned with plural light-guiding structures 32. After the light beam B is projected to the keycap 30, the light beam B is guided to the character/symbol region 301 by the light-guiding structures 32. Then, the light beam B is transmitted through the character/symbol region 301 to illuminate the character/symbol region 301. In an embodiment, the light-guiding structures 32 are located under the corresponding character/symbol region 301. For example, the light-guiding structures 32 are light-guiding microstructures or texturing structures. Moreover, the keycap 30 is made of a transparent material. The top surface of the keycap 30 excluding the plural character/symbol regions 301 is coated with black paint. The other portion of the keycap 30 (e.g., the bottom surface of the keycap 30) is also transparent. After the light beam B is introduced into the keycap 30 from the bottom side of the keycap 30, the light beam B is shielded by the black paint. Consequently, the light beam B can still pass through the plural character/symbol regions 301.

The operations of depressing the keycap 30 will be described as follows. While the keycap 30 is depressed by the user, the keycap 30 is moved downwardly relative to the base plate 36. Since the connecting element 33 is pushed by the keycap 30, the connecting element 33 is correspondingly swung. Moreover, as the keycap 30 is moved downwardly to push the elastic element 34, the elastic element 34 is subjected to deformation to trigger the switching circuit board 35. Consequently, the corresponding key signal is generated. When the keycap 30 is no longer depressed, the keycap 30 is moved upwardly relative to the base plate 36 in response to a restoring elastic force of the elastic element 34. As the keycap 30 is moved upwardly, the connecting element 33 is correspondingly swung. Consequently, the keycap 30 is returned to its original position.

After the side-view light emitting element 312 is driven to emit the light beam B, the light beam B is introduced into the light guide plate 313 and the light beam B is subjected to total internal reflection within the light guide plate 313. Then, the light beam B is guided to the keycap 30 by the light guide plate 313. Then, the light beam B is introduced into the keycap 30 from the bottom side of the keycap 30 and the light beam B is subjected to total internal reflection within the keycap 30. When the light beam B is projected on the light-guiding structures 32 under the character/symbol regions 301, the total internal reflection of the light beam B is destroyed by the light-guiding structures 32. Consequently, the travelling direction of the light beam B is changed, and the light beam B is projected to the corresponding character/symbol regions 301. After the light beam B is transmitted through the character/symbol regions 301, all of the character/symbol regions 301 are illuminated. In other words, the luminous uniformity of the keycap 30 is enhanced.

The following two aspects should be specially described. Firstly, in the above embodiment, the light guide plate 313 is located over the base plate 34. It is noted that the relative positions between the light guide plate and the base plate are not restricted. For example, in another embodiment, the light guide plate is located under the base plate. Under this circumstance, the base plate comprises openings for allowing the light beam to pass through. Secondly, the means for fixing the keycap is not restricted to the scissors-type connecting element. For example, in another embodiment, another type of connecting element or a magnetic structure may be employed to fix the keycap as long as the keycap is movable relative to the base plate.

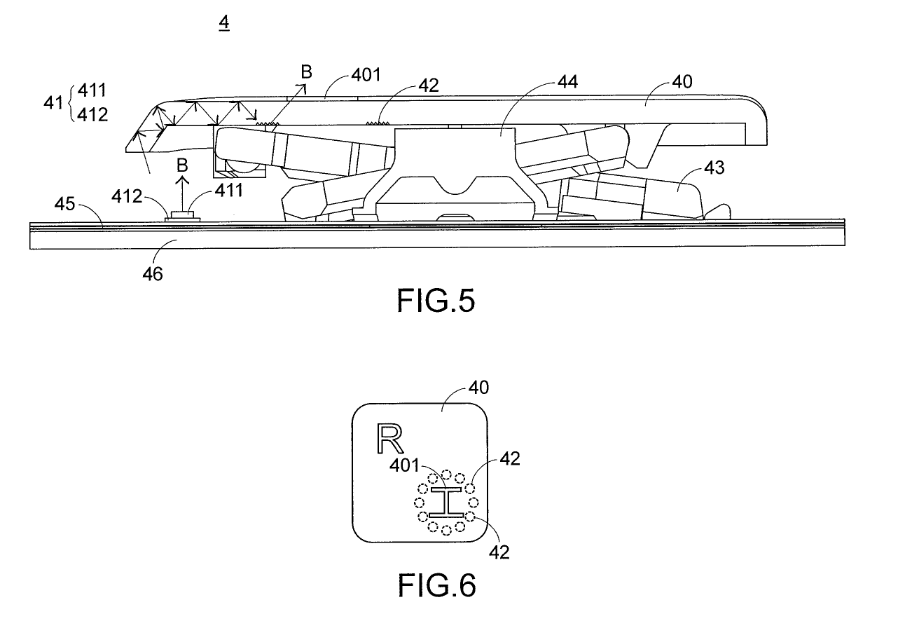

The present invention further provides a second embodiment, which is distinguished from the first embodiment. Please refer to FIGS. 5 and 6. FIG. 5 is a schematic cross-sectional view illustrating a luminous keyboard according to a second embodiment of the present invention. FIG. 6 is a schematic top view illustrating a keycap of the luminous keyboard according to the second embodiment of the present invention. In this embodiment, the luminous keyboard 4 comprises plural keycaps 40, an illumination module 41, plural light-guiding structures 42, plural connecting elements 43, plural elastic elements 44, a switching circuit board 45 and a base plate 46. For succinctness, only one keycap 40, one connecting element 43 and one elastic element 44 are shown in the drawings. Each keycap 40 comprises plural character/symbol regions 401. For example, as shown in FIG. 6, the plural character/symbol regions 401 contain a character/symbol region “R” and a character/symbol region “ [symbol] ”. Except for the following two items, the structures and functions of the components of the luminous keyboard 4 are similar to those of the luminous keyboard 3 of the first embodiment. Firstly, the structure of the illumination module 41 is distinguished. Secondly, the positions of the plural light-guiding structures 42 are distinguished. The operations of the luminous keyboard 4 of this embodiment are similar to those of the first embodiment, and are not redundantly described herein.

As shown in FIG. 5, the illumination module 41 comprises a top-view light emitting diode 411 and an illumination circuit board 412. The illumination circuit board 412 is located over the switching circuit board 45. The top-view light emitting diode 411 is installed on the illumination circuit board 412. When the top-view light emitting diode 411 is driven to emit a light beam B, the light beam B is directly projected to the keycap 40. Since the luminous keyboard of this embodiment comprises the top-view light emitting diode, it is not necessary to install the light guide plate.

As shown in FIGS. 5 and 6, the plural light-guiding structures 42 are disposed on a bottom surface of the keycap 40. Each character/symbol region 401 is aligned with plural light-guiding structures 42. Moreover, as shown in FIG. 6, the plural light-guiding structures 42 are arranged around the underlying position of the corresponding character/symbol region 401. After the top-view light emitting diode 411 is driven to emit the light beam B, the light beam B is introduced into the keycap 40 from the bottom side of the keycap 40 and the light beam B is subjected to total internal reflection within the keycap 40. When the light beam B is projected on the light-guiding structures 42 around the underlying position of the character/symbol regions 401, the total internal reflection of the light beam B is destroyed by the light-guiding structures 42. Consequently, the travelling direction of the light beam B is changed, and the light beam B is transmitted through the corresponding character/symbol region 401. Consequently, the luminous uniformity of the keycap 40 is enhanced.

In the first embodiment, the light-guiding structures 32 are located under the corresponding character/symbol region 301. In the second embodiment, the light-guiding structures 42 are arranged around the underlying position of the corresponding character/symbol region 401. Due to the optical diffusion property of the light beam B, the light beam B can be guided to the character/symbol region. In an embodiment, some light-guiding structures are located under the corresponding character/symbol region and some light-guiding structures are arranged around the underlying position of the corresponding character/symbol region. Since arrangements of the light-guiding structures in the first embodiment and the second embodiment are combined together, the light-guiding efficacy is enhanced.

From the above descriptions, the present invention provides the luminous keyboard. The light-guiding structures are disposed on the bottom surface of the keycap. Consequently, the light-guiding structures are located under the corresponding character/symbol region or located near the corresponding character/symbol region. The light-guiding structures of the luminous keyboard are arranged according to the layout of the character/symbol regions in different countries. It is not necessary to change the light-guiding structures of the light guide plate according to the layout of the character/symbol regions of different countries. Consequently, the luminous keyboard of the present invention can overcome the drawbacks of the conventional technologies.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A luminous keyboard, comprising:
an illumination module generating a light beam;
plural keycaps located over or above the illumination module, wherein at least one specified keycap of the plural keycaps comprises a character/symbol region, and the character/symbol region is exposed to a top surface of the specified keycap, wherein the light beam is projected to the keycap; and
plural light-guiding structures disposed on a bottom surface of the specified keycap and aligned with the character/symbol region, wherein the light beam to be projected to the specified keycap is guided to the character/symbol region by the light-guiding structures, so that the character/symbol region is illuminated.

2. The luminous keyboard according to claim 1, wherein the plural light-guiding structures are located under the character/symbol region.

3. The luminous keyboard according to claim 1, wherein the plural light-guiding structures are arranged around an underlying position of the character/symbol region.

4. The luminous keyboard according to claim 1, wherein the light-guiding structures are light-guiding microstructures or texturing structures.

5. The luminous keyboard according to claim 1, wherein the illumination module comprises a top-view light emitting diode.

6. The luminous keyboard according to claim 1, wherein the illumination module comprises:
a side-view light emitting element located below the specified keycap, and generating the light beam; and
a light guide plate located under the specified keycap and located beside the side-view light emitting element, wherein after the light beam is introduced into the light guide plate, the light beam is guided to the specified keycap by the light guide plate.

7. The luminous keyboard according to claim 1, further comprising:
plural connecting elements connected with the plural keycaps, so that the plural keycaps are movable upwardly or downwardly;
plural elastic elements located under the corresponding keycaps, wherein when the elastic elements are pushed by the corresponding keycaps, the plural elastic elements are subjected to deformation;
a switching circuit board located under the plural elastic elements, wherein when the switching circuit board is triggered by one of the plural elastic elements, a corresponding key signal is generated; and
a base plate located under the switching circuit board and connected with the plural connecting elements, wherein the switching circuit board is supported by the base plate.

8. The luminous keyboard according to claim 7, wherein when the elastic elements are not pushed by the corresponding keycaps, the elastic elements provide elastic forces to the corresponding keycaps, so that the corresponding keycaps are moved upwardly.

9. The luminous keyboard according to claim 7, wherein the connecting elements are scissors-type connecting elements.

10. The luminous keyboard according to claim 7, wherein the elastic elements are rubbery elastomers.
